(19) United States
(12) Patent Application Publication
(10) Pub. No.: US 2026/0097604 A1
(43) Pub. Date: Apr. 9, 2026

(54) TWO-WAY VIEWING STORYBOOK SYSTEM AND METHOD

(71) Applicant: Uzra Vo, Tempe, AZ (US)

(72) Inventor: Uzra Vo, Tempe, AZ (US)

(21) Appl. No.: 19/353,052

(22) Filed: Oct. 8, 2025

Related U.S. Application Data
(60) Provisional application No. 63/704,650, filed on Oct. 8, 2024.

(51) Int. Cl. B42D 1/00

(52) U.S. Cl. CPC B42D 1/00

(57) ABSTRACT

A two-way viewing storybook system and method is disclosed herein. The storybook includes a front cover, a back cover, and a plurality of pages bound between covers. Each of the plurality of pages includes a first story text printed on a first side in standard readable size and accompanied by illustrations. The back cover includes a condensed-sized reproduction of the first story text. The method includes positioning the book for the audience, reading from the back cover, and completing a story without adjusting posture, allowing a seamless and ergonomic storytelling experience.

### CROSS-REFERENCE TO RELATED APPLICATION(S)

The present application is related to and claims priority to U.S. Provisional Patent Application No. 63/704,650 filed Oct. 8, 2024, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of books of existing art and more specifically relates to a two-way storybook.

### RELATED ART

Storytelling has long been a cherished tradition, especially in educational and entertainment settings involving children. During story time, readers often position a book so that an audience, typically seated in front of them, can see the illustrations and follow along visually. However, in doing so, the reader is forced into an awkward position where they must tilt their head or glance down repeatedly to read the text, which can be physically straining, particularly during extended reading sessions. This awkward posture places strain on the neck, back, and shoulders, leading to discomfort and fatigue for the reader. Over time, this discomfort can detract from the enjoyment of storytelling, limiting the reader's ability to engage dynamically with their audience, and potentially diminishing the overall story experience.

Moreover, traditional storybooks require the reader to turn pages frequently, which disrupts the storytelling flow and can further complicate maintaining eye contact with the audience. As a result, many readers, especially teachers, librarians, and parents who regularly read to children, seek ways to enhance both their comfort and the quality of their presentation. Existing solutions, such as using larger-format books or reading from a script, may help to some extent but often lack the seamless integration of visual storytelling with verbal narration. A suitable solution is desired.

U.S. Pub. No. 2004/0175678 to Marx relates to a unique, new reading method for children's picture books. The described unique, new reading method for children's picture books allows the audience to always see the pictures of a picture book while the story is being read from the back two pages of the book! Numbered tabs allow smooth turning from one picture to the next while continuing to read the story from those back pages. There is also no need to remove the picture from the audience's view to answer questions. The pictures are also on the back pages along with the words.

### SUMMARY OF THE INVENTION

In view of the foregoing disadvantages inherent in the known two-way storybook art, the present disclosure provides a novel two-way viewing storybook system. The general purpose of the present disclosure, which will be described subsequently in greater detail, is to provide a two-way viewing storybook system.

A two-way viewing storybook system is disclosed herein. The two-way viewing storybook system provides a means to facilitate story reading in a format allowing simultaneous viewing by both a reader and an audience. The two-way viewing storybook system includes a storybook having a front cover, a back cover, and a plurality of pages bound between said front cover and back cover. The front side of the pages presents a first story text in standard readable size accompanied by illustrations, while a back cover presents a second story text, which is a condensed-sized reproduction of the first story text. The two-way viewing storybook system allows a user to read from the back cover while an audience views the first story text and illustrations. The second story text comprises a condensed reproduction of the first story text sufficient to allow full reading of the storybook from the back cover alone. Allowing for a reader to follow a complete story without needing to reference an audience-facing side, facilitating ergonomic and uninterrupted storytelling during outward presentation.

A method of using a two-way viewing storybook system is also disclosed herein including the steps of: positioning a storybook such that a first side of a plurality of pages face an audience; viewing a second story text on a back cover; reading a story aloud from the second story text while the audience observes a first story text and illustrations; maintaining orientation of the storybook throughout reading; and completing a reading session and closing the storybook; and maintaining eye contact with the audience while reading the second story text.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a two-way viewing storybook system, constructed and operative according to the teachings of the present disclosure.

FIG. 1 is a perspective view of the two-way viewing storybook system during an ‘in-use’ condition, according to an embodiment of the disclosure.

FIG. 2 is a perspective view of the two-way viewing storybook system of FIG. 1, according to an embodiment of the present disclosure.

FIG. 3 is a perspective view of the two-way viewing storybook system of FIG. 1, according to an embodiment of the present disclosure.

FIG. 4 is a perspective view of the two-way viewing storybook system of FIG. 1, according to an embodiment of the present disclosure.

FIG. 5 is a flow diagram illustrating a method of use for two-way viewing storybook system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a two-way storybook and more particularly to a two-way viewing storybook system as used to improve the comfort and storytelling efficiency.

Generally, two-way viewing storybook system provides a means to facilitate story reading in a format allowing simultaneous viewing by both a reader and an audience. The two-way viewing storybook system includes a storybook having a front cover, a back cover, and a plurality of pages bound between the front cover and the back cover. The front side of the pages presents a first story text in standard readable size accompanied by illustrations, while the back cover presents a second story text, which is a condensed-sized reproduction of the first story text. The two-way viewing storybook system allows a user to read from the back cover while an audience views the first story text and illustrations.

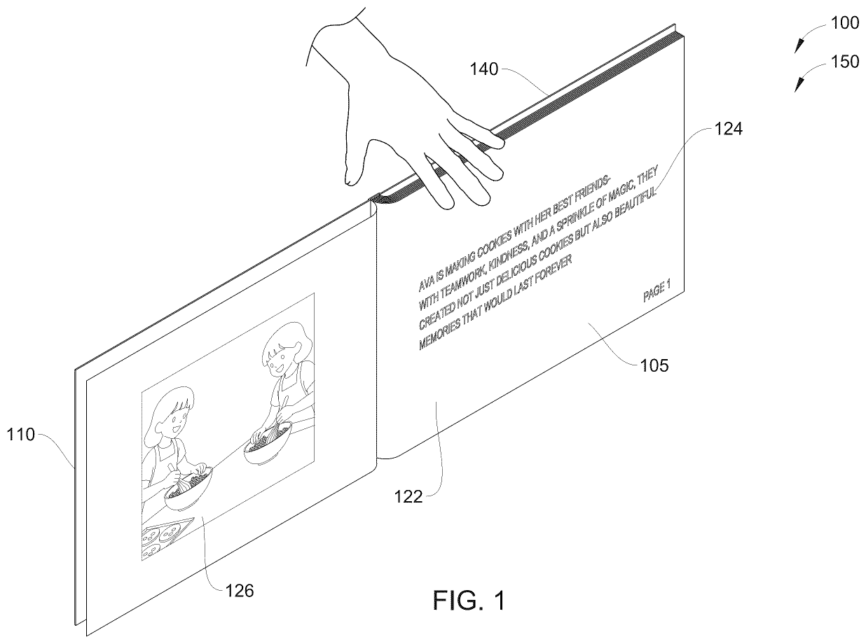

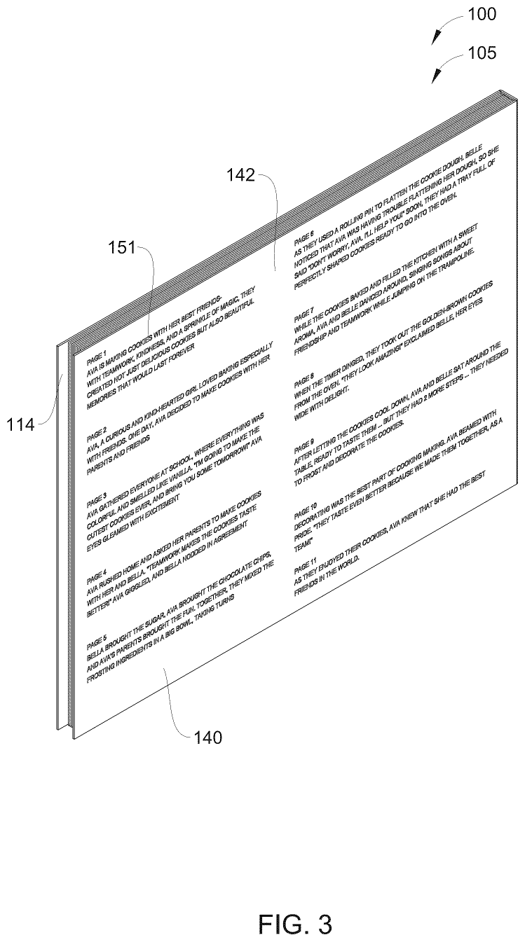

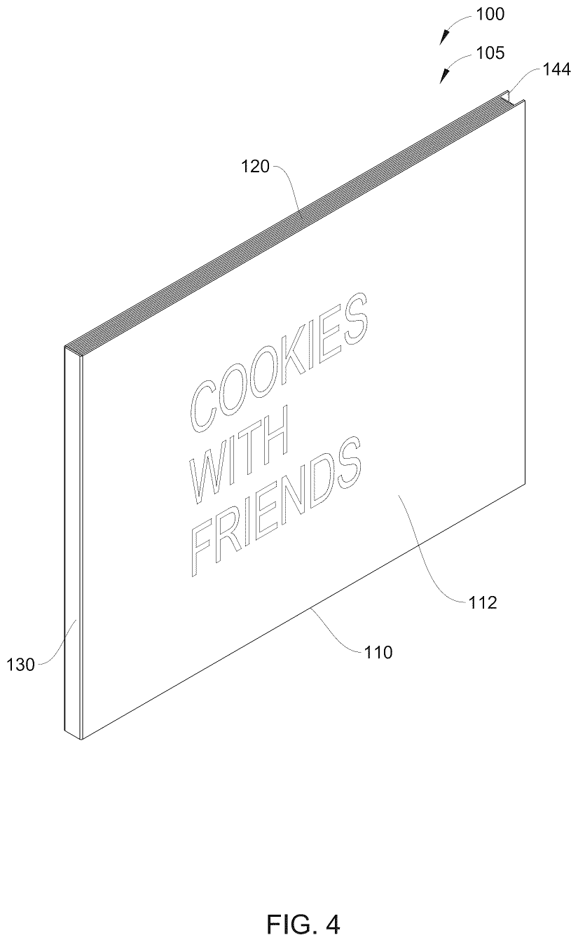

Referring now more specifically to the drawings by numerals of reference, there is shown in FIGS. 1-4, various views of a two-way viewing storybook system 100.

FIG. 1 shows a two-way viewing storybook system 100 during an ‘in-use’ condition 150, according to an embodiment of the present disclosure. Here, the two-way viewing storybook system 100 is provided to address both ergonomic and practical challenges that arise when reading to an audience, such as minimizing a need for a reader to continuously turn pages while maintaining eye contact, improving posture, and facilitating audience engagement. As illustrated, the storybook 105 includes a front cover 110, a back cover 140, and a plurality of pages 120 bound between the front cover 110 and back cover 140 along a spine 130.

The front cover 110 includes a front exterior surface 112 and a front interior surface 114, providing structural rigidity and a visually appealing front-facing presentation. The back cover 140 includes a back exterior surface 142 and a back interior surface 144. The plurality of pages 120 includes a first story text 124 printed on a first side 122 of each page in standard readable size, accompanied by illustrations 126 positioned adjacent to the first story text 124. The back exterior surface 142 is configured to display a second story text 151, which is a condensed-sized reproduction of the first story text 124, allowing the reader to access the complete story in a single view. The illustrations 126 may vary in size, orientation, and style but are consistently arranged to complement a story narrative, highlight key story elements, and enhance audience engagement. The plurality of pages 120 are preferably rectangular and uniform in height and width, providing consistent alignment along the spine 130 and ease of handling during reading sessions. Uniform page dimensions also facilitate binding, stacking, and storage while ensuring that the front-facing story maintains a professional and predictable appearance.

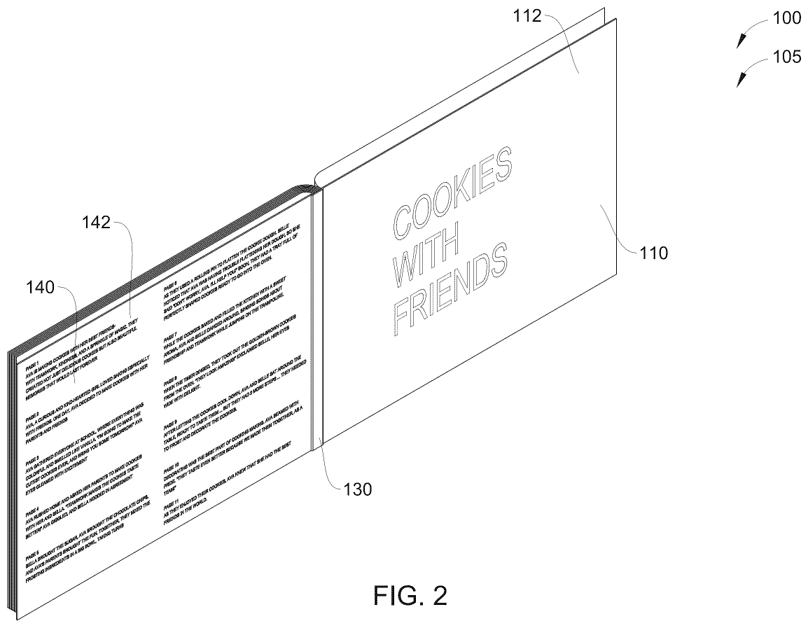

Referring now to FIGS. 2-4, the storybook 105 is further illustrated in various perspectives. The back exterior surface 142 of the back cover 140 displays the second story text 151, which contains a condensed but complete narrative of the storybook 105. The second story text 151 is formatted to reduce font size, line spacing, and margins relative to the first story text 124, allowing the entire story to be visible in a single, consolidated layout on the back cover 140. This arrangement eliminates the need for the reader to flip through pages or to constantly reference the audience-facing side while narrating. The condensed text 151 may be organized into paragraphs, sections, or multiple columns to optimize readability and allow quick reference during live reading.

The second story text 151 may be printed directly onto the back exterior surface 142 using conventional printing methods, digital printing, or high-resolution offset techniques, providing a durable and visually clear reproduction of the full story. Alternatively, the second story text 151 may be applied as a label, overlay, or printed insert affixed permanently to the back cover 140. In all embodiments, the second story text 151 preferably occupies substantially the full area of the back exterior surface 142, maximizing readability while maintaining proportional alignment with the layout and sequencing of the first story text 124 on the plurality of pages 120. Optional visual alignment marks, borders, or shading may be provided to help the reader maintain proper orientation when viewing the second story text 151.

The second story text 151 is arranged sequentially to correspond with the order of the first story text 124 across the plurality of pages 120, preserving a narrative flow of a story. This alignment allows a reader to follow the story in proper order while observing the condensed text on the back cover 140. In some embodiments, the condensed text may include paragraph numbers, section identifiers, or small markers referencing the corresponding pages or segments of the first story text 124 to further aid navigation.

The front cover 110 and the back cover 140 are each formed of rigid or semi-rigid board material to provide structural stability and protect the plurality of pages 120 during handling, reading, or transport. In some embodiments, flexible materials may also be used provided they maintain sufficient support to ensure that the second story text 151 on the back exterior surface 142 remains flat and legible. The front cover 110 and back cover 140 are dimensioned to enclose the plurality of pages 120 in a closed position, protecting the pages from bending, damage, or exposure to environmental factors such as moisture, dust, or sunlight. The back cover 140 may additionally be coated or laminated with protective finishes, such as gloss, matte, or UV-resistant coatings, to enhance durability and resist wear and tear from repeated use.

The plurality of pages 120 are bound along the spine 130 connecting the front cover 110 and back cover 140. Conventional binding methods may be used, including but not limited to, adhesive binding, stitched binding, or mechanical ring binding. The binding ensures the pages 120 remain securely fastened while allowing smooth page-turning during reading. The rectangular and uniform dimensions of the plurality of pages 120 facilitate consistent alignment along the spine 130, ensuring the storybook 105 maintains a neat and organized appearance.

The first story text 124 and second story text 151 correspond in narrative sequence, allowing the reader to simultaneously reference the condensed narrative on the back cover 140 while reading aloud the first story text 124 and illustrations 126 on the plurality of pages 120. The second story text 151 may be printed using ink resistant to smudging, fading, or moisture, thereby maintaining durability and readability through repeated handling and over extended periods of use.

During operation, a user holds the two-way viewing storybook system with the first side 122 of the plurality of pages 120 facing an audience, while the second story text 151 remains upright and readable to the user from the back exterior surface 142 of the back cover 140. This configuration allows ergonomic reading without requiring the reader to rotate their body or the storybook 105 excessively. It also facilitates continuous storytelling while maintaining visual contact with the audience, thereby enhancing engagement and comprehension.

The second story text 151 on the back cover 140 may include optional formatting features to further enhance usability and readability. Such features may include headers, titles, paragraph markers, multiple columns, bullet points, or even dual-language versions. In some embodiments, decorative borders or visual alignment guides may be provided to help the reader maintain orientation while reading, especially for longer or complex stories. A layout and design of the second story text 151 may be adapted depending on the target audience, age range, or specific application of the storybook 105.

Overall, the two-way viewing storybook system 100 provides a practical, ergonomic, and versatile solution for reading to audiences, particularly children or groups, allowing the reader to maintain natural posture, ensure narrative continuity, and engage the audience without constantly adjusting the storybook 105 or losing eye contact. A combination of a first story text 124 with illustrations 126 and a condensed second story text 151 on the back cover 140 ensures that the story can be read both interactively for an audience and efficiently by the reader alone.

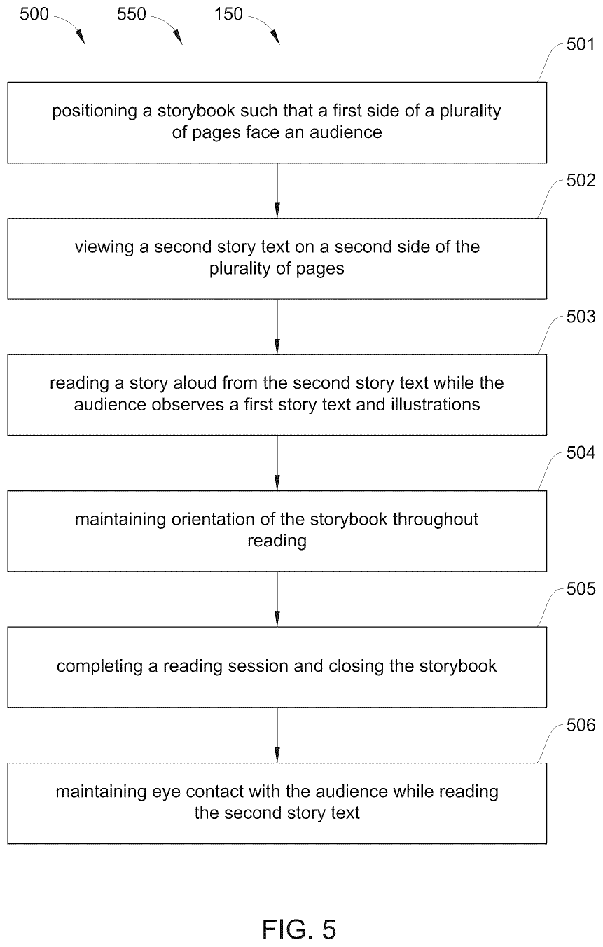

Referring now to FIG. 5 showing a flow diagram illustrating a method of use 500 for a two-way viewing storybook system, according to an embodiment of the present disclosure. In particular, the method of use 500 may include one or more components or features of the two-way viewing storybook system 100 as described above. As illustrated, the method of use 500 may include the steps of: step one 501, positioning a storybook such that a first side of a plurality of pages face an audience; step two 502, viewing a second story text on a back cover; step three 503, reading a story aloud from the second story text while the audience observes a first story text and illustrations; step four 504, maintaining orientation of the storybook throughout reading; step five 505, completing a reading session and closing the storybook; and step six 506, maintaining eye contact with the audience while reading the second story text.

It should also be noted that the steps described in the method of use can be carried out in many different orders according to user preference. The use of “step of” should not be interpreted as “step for”, in the claims herein and is not intended to invoke the provisions of 35 U.S.C. § 112 (f). It should also be noted that, under appropriate circumstances, considering such issues as design preference, user preferences, marketing preferences, cost, structural requirements, available materials, technological advances, etc., other methods for using a two-way viewing storybook system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A two-way viewing storybook system comprising:
a storybook having;
a front cover having a front exterior surface and a front interior surface;
a back cover having a back interior surface and a back exterior surface;
a plurality of pages bound between said front cover and said back cover;
said plurality of pages including a first story text printed on a first side in standard readable size and accompanied by illustrations;
a second story text is positioned on said back exterior surface of said back cover, said second story text being a condensed-sized reproduction of said first story text.

2. The two-way viewing storybook system of claim 1, wherein said condensed-sized reproduction of said first story text is printed in reduced font size, line spacing, and margins relative to said first story text.

3. The two-way viewing storybook system of claim 1, wherein said plurality of pages are bound along a spine connecting said front cover and said back cover.

4. The two-way viewing storybook system of claim 1, wherein said first story text and said second story text correspond in narrative sequence.

5. The two-way viewing storybook system of claim 1, wherein said front cover and said back cover are each formed of rigid or semi-rigid board material.

6. The two-way viewing storybook system of claim 5, wherein said front cover and said back cover are dimensioned to enclose said plurality of pages in a closed position.

7. The two-way viewing storybook system of claim 1, wherein said second story text is printed directly onto said back cover.

8. The two-way viewing storybook system of claim 1, wherein said second story text is applied by label, overlay, or printed insert affixed to said back cover.

9. The two-way viewing storybook system of claim 1, wherein said second story text covers substantially a full area of said back cover.

10. The two-way viewing storybook system of claim 1, wherein said condensed-sized reproduction is aligned sequentially to match an order of said first story text across said plurality of pages.

11. The two-way viewing storybook system of claim 1, wherein said condensed-sized reproduction is printed using ink resistant to smudging and fading.

12. The two-way viewing storybook system of claim 1, wherein said plurality of pages are configured to display said illustrations adjacent to said first story text on said first side.

13. The two-way viewing storybook system of claim 1, wherein said second story text is arranged on said back cover in a format corresponding to the layout of said first story text.

14. The two-way viewing storybook system of claim 13, wherein said second story text on said back cover includes said condensed-sized reproduction of an entire storybook.

15. The two-way viewing storybook system of claim 1, wherein said plurality of pages are rectangular and uniform in height and width.

16. The two-way viewing storybook system of claim 1, wherein said second story text comprises a condensed reproduction of said first story text sufficient to allow full reading of said storybook from said back cover alone.

17. The two-way viewing storybook system of claim 1, wherein said back cover having said second story text is oriented such that when said storybook is held facing an audience, said second story text remains upright and readable to a user positioned opposite said audience.

18. A two-way viewing storybook system, the two-way viewing storybook system comprising:
a storybook having;
a front cover having a front exterior surface and a front interior surface;
a back cover having a back interior surface and a back exterior surface;
a plurality of pages bound between said front cover and said back cover;
said plurality of pages including a first story text printed on a first side in standard readable size and accompanied by illustrations;
a second story text is positioned on said back exterior surface of said back cover, said second story text being a condensed-sized reproduction of said first story text;
wherein said condensed-sized reproduction of said first story text is printed in reduced font size, line spacing, and margins relative to said first story text;
wherein said plurality of pages are bound along a spine connecting said front cover and said back cover;
wherein said first story text and said second story text correspond in narrative sequence;
wherein said front cover and said back cover are each formed of rigid or semi-rigid board material;
wherein said front cover and said back cover are dimensioned to enclose said plurality of pages in a closed position;
wherein said second story text is printed directly onto said back cover;
wherein said second story text is applied by label, overlay, or printed insert affixed to said back cover;
wherein said second story text covers substantially a full area of said back cover;
wherein said condensed-sized reproduction is aligned sequentially to match an order of said first story text across said plurality of pages;
wherein said condensed-sized reproduction is printed using ink resistant to smudging and fading;
wherein said plurality of pages are configured to display said illustrations adjacent to said first story text on said first side;
wherein each of said plurality of pages includes a first side and a second side configured for printing of said first story text;
wherein said second story text is arranged on said back cover in a format corresponding to the layout of said first story text;
wherein said second story text on said back cover includes said condensed-sized reproduction of an entire storybook;
wherein said plurality of pages are rectangular and uniform in height and width;
wherein said second story text comprises a condensed reproduction of said first story text sufficient to allow full reading of said storybook from said back cover alone; and
wherein said back cover having said second story text is oriented such that when said storybook is held facing an audience, said second story text remains upright and readable to a user positioned opposite said audience.

19. A method of reading a two-way viewing storybook, comprising the steps of:
positioning a storybook such that a first side of said plurality of pages face an audience;
viewing a second story text on a back cover;
reading a story aloud from said second story text while said audience observes a first story text and illustrations;
maintaining orientation of said storybook throughout reading; and completing a reading session and closing said storybook.

20. The method of claim 19, further comprising the steps of:
maintaining eye contact with said audience while reading said second story text.
